(19) United States
(12) Patent Application Publication
(10) Pub. No.: US 2017/0198793 A1
(43) Pub. Date: Jul. 13, 2017

(54) TORQUE CONVERTERS AND METHODS FOR ASSEMBLING THE SAME

(71) Applicant: Caterpillar Inc., Peoria, IL (US)

(72) Inventor: Joseph A. Degregorio, Peoria, IL (US)

(73) Assignee: Caterpillar Inc., Peoria, IL (US)

(21) Appl. No.: 14/989,902

(22) Filed: Jan. 7, 2016

(51) Int. Cl. F16H 41/24; F16H 57/00; F16H 61/56

(52) U.S. Cl. CPC F16H 41/24; F16H 61/56; F16H 57/0006

(57) ABSTRACT

Torque converters and methods of using torque converters are disclosed. An example torque converter includes an impeller including an impeller blade, a turbine including a turbine blade, and a stator disposed between the impeller and the turbine. The stator includes a stator blade. At least one of a leading edge of the impeller blade, a leading edge of the turbine blade, or a leading edge of the stator blade includes tubercles.

### TECHNICAL FIELD

This disclosure relates generally to fluid coupling devices, and more particularly, to torque converters and methods of using the same.

### BACKGROUND

Powertrains of many vehicles generally include an engine, a transmission, and a mechanism to operatively couple the engine and the transmission to selectively transfer torque from the engine to the transmission. In some powertrains, a torque converter is used as the mechanism to transmit power between an engine and a transmission. Torque converters generally include an impeller and a turbine that are hydrodynamically coupled. The impeller is driven by an output of the engine to force fluid within the torque converter towards the turbine. In response to this moving fluid, the turbine is forced to rotate, thereby resulting in a rotational input to the transmission. In addition to the impeller and the turbine, a torque converter also includes a stator that is configured to redirect fluid from the turbine back towards the impeller.

United States Patent Application Publication No. 2011/0311367 to Shiomura et al. describes a known torque converter that includes an impeller, a turbine, and a stator. That stator in this known torque converter includes stator blades with outlet-side or trailing edges having a corrugated shape defined by a plurality of concave and convex portions. The corrugated shape of the outlet-side trailing edges of the stator blades serve to inhibit efficiency reduction due to vortices generated in the fluid separating off the outlet-side trailing edges of the stator blades. To that end, the corrugated shape of the outlet-side trailing edges of the stator blades generate a plurality of small vortices that tend to cancel each other out. However, this effect may be minimal where flow separation occurs before reaching the trailing edge. In some applications of torque converters, such as, for example in heavy equipment vehicles (e.g., bulldozers, loaders, mining equipment, steel factory vehicles, agricultural equipment, etc.), the stator blades are subject to relatively high angles of attack of fluid where flow separation is likely during most of the duty cycle of the torque converter. As such, corrugated trailing edges may be minimally effective in such applications and do little to reduce the onset of flow separation.

Furthermore, there are hydrodynamic forces other than those created by vortices generated on the trailing edge of stator blades that can reduce or limit the efficiency or performance of a torque converter. For example, low velocity fluid flow due to stagnation at the leading edges of stator blades can produce a high pressure region along the leading edges. This high pressure region results in drag, which has a negative impact on the efficiency of the torque converter. Corrugated outlet-side or trailing edges on stator blades, as described in the known torque converter discussed above, do not assist in reducing stagnation along leading edges of the stator blades. Furthermore, the above known torque converter does not address leading edge stagnation on the blades of either the turbine or the impeller in a torque converter.

### SUMMARY

Torque converter blades including tubercles are disclosed herein. An example torque converter includes an impeller including an impeller blade, a turbine including a turbine blade, and a stator disposed between the impeller and the turbine. The stator includes a stator blade. At least one of a leading edge of the impeller blade, a leading edge of the turbine blade, or a leading edge of the stator blade includes tubercles.

An example apparatus includes an impeller including an impeller blade, a turbine including a turbine blade, and a stator including a stator blade, the stator disposed between the impeller and the turbine. The example apparatus further includes means for reducing stagnation on a leading edge of at least one of the impeller blade, the turbine blade, or the stator blade.

An example method disclosed herein includes forcing a fluid within a torque converter to move based on rotation of an impeller within the torque converter driven by a rotational power input. The impeller includes an impeller blade. The example method includes rotating a turbine in response to movement of the fluid to transfer the rotational power input to an output. The turbine includes a turbine blade. The example method further includes redirecting the fluid moving from the turbine toward the impeller via a stator. The stator includes a stator blade. At least one of the impeller blade, the turbine blade, or the stator blade includes tubercles on a leading edge.

### BRIEF DESCRIPTION OF THE DRAWINGS

FIG. 1 is cutaway view of an example torque converter constructed in accordance with teachings of this disclosure and shown in an example environment of use.

FIG. 2 is an isometric view of the example impeller of FIG. 1 including an enlargement of a part thereof.

FIG. 3 is an isometric view of the example turbine of FIG. 1 including an enlargement of a part thereof.

FIG. 4 is an isometric view of the example stator of FIG. 1 including an enlargement of a part thereof.

FIG. 5 is an isometric view of another example impeller that may alternatively be implemented in the example torque converter of FIG. 1 including an enlargement of a part thereof.

FIG. 6 is an isometric view of another example turbine that may alternatively be implemented in the example torque converter of FIG. 1 including an enlargement of a part thereof.

FIG. 7 is an isometric view of another example stator that may alternatively be implemented in the example torque converter of FIG. 1 including an enlargement of a part thereof.

FIG. 8 is a cutaway view of an impeller blade of the example impeller of FIG. 2.

FIG. 9 is a c cutaway view of a turbine blade of the example turbine of FIG. 3.

FIG. 10 is a view of a stator blade of the example stator of FIG. 4.

FIG. 11 is a cutaway view of an impeller blade of the example impeller of FIG. 5.

FIG. 12 is a cutaway view of a turbine blade of the example turbine of FIG. 6.

FIG. 13 is a cutaway view of a stator blade of the example stator of FIG. 7.

FIGS. 14 and 15 are plan views illustrating example tubercles on leading edges of blades similar to the example impeller blades, turbine blades, and stator blades of FIGS. 2-4 and 8-10.

FIGS. 16 and 17 are plan views illustrating example tubercles on leading edges of blades similar to the example impeller blades, turbine blades, and stator blades of FIGS. 5-7 and 11-13.

FIG. 18 is a chart illustrating estimated increases in torque ratio achieved by example torque converters constructed in accordance with the teachings of this disclosure relative to conventional torque converters.

### DETAILED DESCRIPTION

The blades used in the impellers, turbines, and stators of known torque converters are typically designed with a smooth leading edge. As used herein, the term “leading edge” refers to the front or inlet edge of a blade facing towards the fluid flow (i.e., upstream, opposed to the direction of fluid flow). The leading edge spans the width of the blade to define a line dividing an upper surface (also referred to as a suction surface) of the blade and a lower surface (also referred to as a pressure surface) of the blade.

Leading edge stagnation on the stator, turbine and/or the impeller blades may contribute to inefficiency in the transfer of power between an engine and a transmission. While power transfer between an engine and a transmission is discussed herein as a specific example application of torque converters, torque converters disclosed herein may be used in other applications to operatively couple different input sources (e.g., gas turbine, electric motor, etc.) with different output sources (e.g., a pump).

Examples disclosed herein reduce the amount of stagnation at a leading edge of a blade by including tubercles on the leading edge of impeller blades, turbine blades, and/or stator blades of a torque converter. As used herein, “tubercles” refer to protrusions (which may be formed by removing material as explained below) oriented in a direction away from the leading edge of a blade (i.e., upstream, opposite the direction of fluid flow). In some examples, the tubercles correspond to nodules, bumps, or other protrusions that extend outward from a baseline surface of the leading edge. In some examples, the tubercles are defined by notches or divots machined into the leading edge. In some such examples, the baseline surface of the leading edge prior to machining corresponds to the outer extent of the tubercles. In some examples, the tubercles may be generally rounded in shape with smooth transitions between the surfaces of the tubercles and the adjacent surfaces. In other examples, the tubercles may have other shapes that include one or more planar surfaces and/or discontinuities between adjacent surfaces (characterized by discrete ridges and/or edges at the interface of such surfaces).

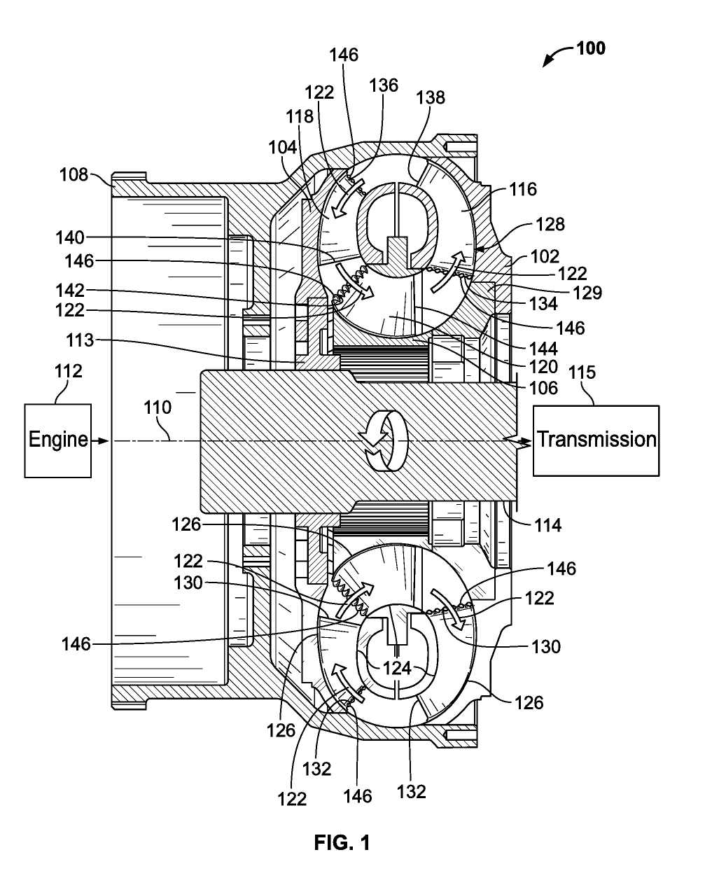

FIG. 1 is cutaway view of an example torque converter 100 constructed in accordance with teachings of this disclosure. The example torque converter of FIG. 1 includes an impeller 102, a turbine 104, and a stator 106 within a housing 108. Each of the impeller 102, the turbine 104, the stator 106, and the housing 108 are structured to rotate about a same axis of rotation 110. In the illustrated example environment of use, the housing 108 is coupled to an engine 112 of a vehicle to rotate with an output of the engine 112. In the example of FIG. 1, the impeller 102 is rigidly coupled to the housing 108. As a result, in the example of FIG. 1, rotation of the impeller 102 is driven by the engine 112.

As shown in the illustrated example, the turbine 104 is disposed inside the housing 108 and operatively coupled (via a turbine hub 113) to an input shaft 114 of a transmission 115 of a vehicle. In some examples, the turbine 104 and the turbine hub 113 are formed as a unitary component. Although the turbine 104 rotates about the same axis 110 as the impeller 102, the turbine 104 and the impeller 102 are free to rotate relative to each other. In this manner, the engine 112 can be rotating the impeller 102 without necessarily providing input to the transmission 115 (i.e., without rotating the turbine 104 when, for example, a brake is applied preventing rotation of the turbine 104). In the illustrated example, torque from the engine 112 may be transmitted to the transmission 115 through a hydrodynamic coupling of the impeller 102 (driven by the engine 112) and the turbine 104 (coupled to the transmission) via fluid in the torque converter 100.

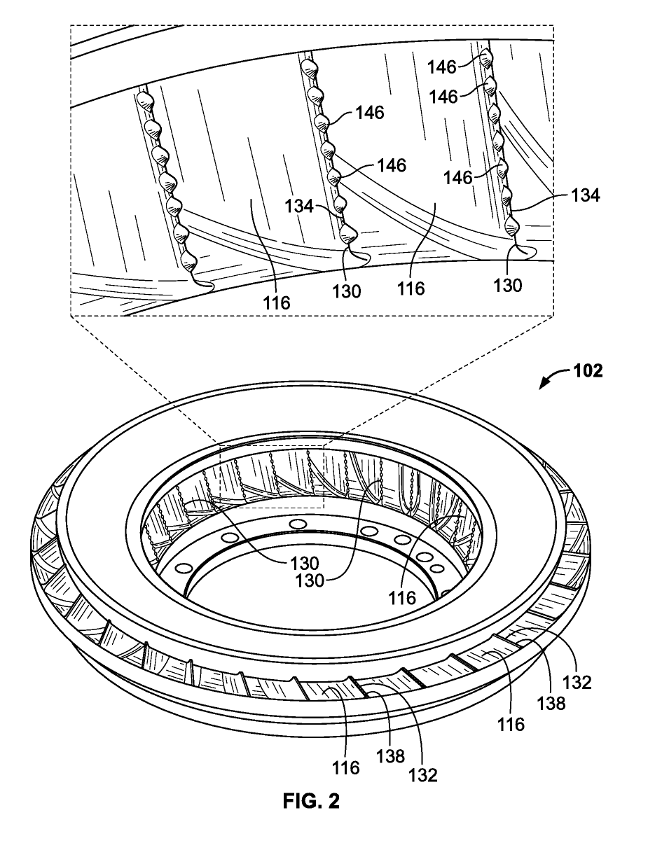

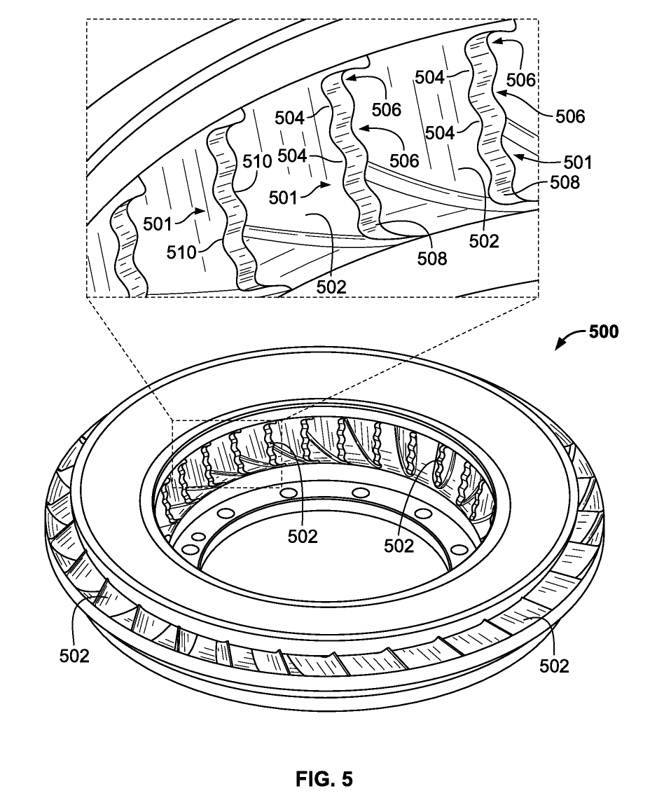

In the example of FIG. 1, the impeller 102 includes impeller blades 116 disposed circumferentially around the axis of rotation 110 of the impeller 102. The impeller blades 116 extend generally radially outward from the axis of rotation 110 (see FIGS. 2 and 5). As the impeller 102 spins about the axis of rotation 110, the impeller blades 116 force fluid (e.g., oil) within the torque converter 100 outwards and towards the turbine 104.

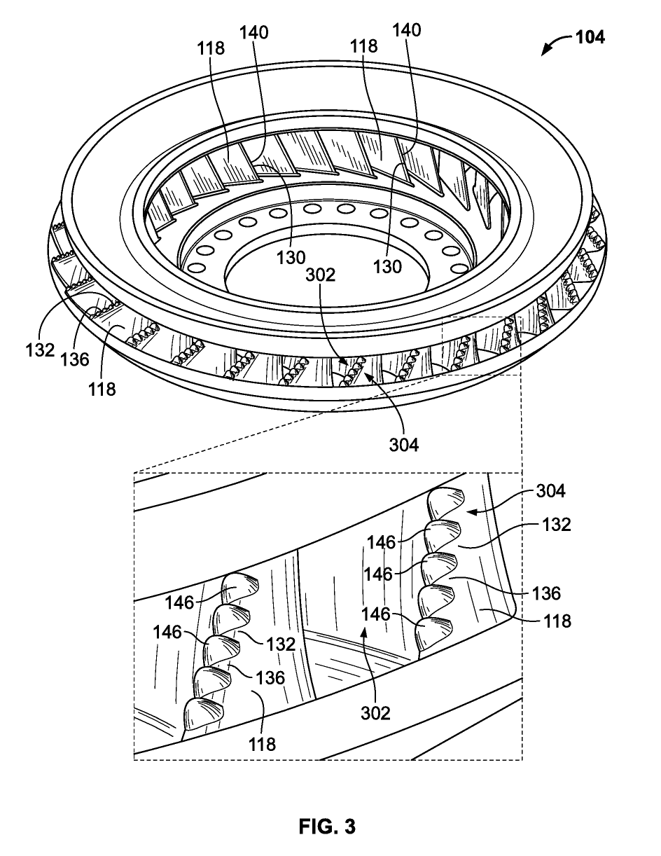

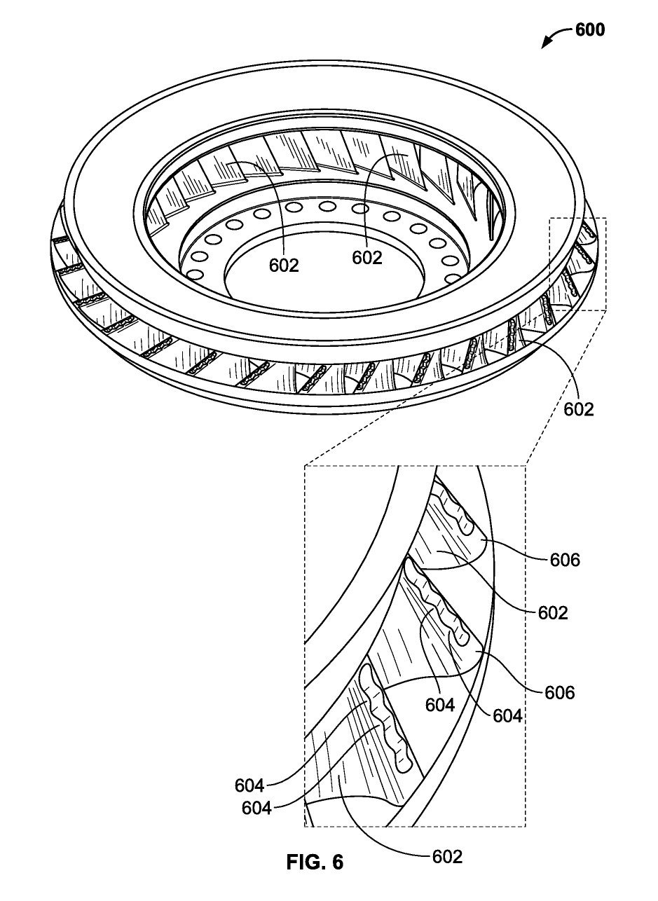

The turbine 104 of the example of FIG. 1 includes turbine blades 118 disposed circumferentially around the axis of rotation 110 of the turbine 104 (see FIGS. 3 and 6). As the fluid is moved by the impeller 102 towards the turbine 104, the fluid may hit the turbine blades 118 and cause the turbine 104 to rotate, thereby transferring power from the engine 112 to the transmission 115 (via rotation of the turbine) unless external forces prevent the rotation of the turbine 104 (e.g., vehicle brakes are being applied). As the turbine 104 rotates, the turbine blades 118 direct the fluid in the torque converter 100 towards the stator 106 disposed, in this example, between the impeller 102 and the turbine 104.

The stator 106 includes stator blades 120 disposed circumferentially around the axis of rotation 110 (see FIGS. 3 and 6). The shape and orientation of the stator blades 120 are such that the fluid flowing off of the turbine blades 118 is redirected towards the impeller blades 116.

Thus, when viewing an isolated cross-section of the torque converter 100, a fluid flow from the impeller blades 116 to the turbine blades 118 to the stator blades 120 and then back to the impeller blades 116 can be represented as following a generally circular path (indicated by arrows 122 in FIG. 1). However, the actual flow path of fluid within the torque converter 100 is not a simple circular path at discrete cross-sections because each of the impeller blades 116, the turbine blades 118, and the stator blades 120 may also be rotating about the axis of rotation 110. As a result, in additional to the circular flow (represented by the arrows 122 in FIG. 1), fluid is also rotated around the axis of rotation 110. The circular flow between each of the blades 116, 118, 120 within a torque converter (represented by the arrows 122) is sometimes referred to as meridional flow, whereas the fluid flow around the axis of rotation 110 is referred to as rotational flow. Meridional flow and rotation flow within a torque converter combine to create a complex flow path not typically experienced in other airfoil type applications where fluid flow is generally one-directional.

Each of the impeller blades 116, the turbine blades 118, and the stator blades 120 of the illustrated example are curved to have a concave side 124 and a convex side 126. Thus, when the impeller 102, the turbine 104, and the stator 106 are assembled, the blades 116, 118, 120 of the example of FIG. 1 define a generally circular (or elliptical) cross-section 128 that facilitates the circular meridional flow. In the illustrated example of FIG. 1, the perimeter of the circular cross-section 128 between the impeller 102 and the turbine 104 is completed by a sidewall of the housing 108. Further, in the example of FIG. 1, the perimeter of the circular cross-section 128 between the stator 106 and the impeller 102 is completed with an impeller hub 129. In other examples, the impeller 102 and the impeller hub 129 may be formed as a unitary component. Rotating the circular cross-section 128 about the axis of rotation 110 defines a torus-shaped chamber around which the fluid is circulated via the rotational flow.

As shown in the example illustrated in FIGS. 1-3, each of the impeller blades 116 and the turbine blades 118 includes a radially inner edge 130 and a radially outer edge 132. The radially inner edge 130 is closer to the axis of rotation 110 than the radially outer edge 132. Based on the direction of the meridional fluid flow (represented by arrows 122 in FIG. 1), the radially inner edge 130 of the impeller blades 116 corresponds to a leading edge 134 of the impeller blades 116 and the radially outer edge 132 of the turbine blades 118 corresponds to a leading edge 136 of the turbine blades 118. Conversely, the radially outer edge 132 of the impeller blades 116 corresponds to a trailing edge 138 of the impeller blades 116 and the radially inner edge 130 of the turbine blades 118 corresponds to a trailing edge 140 of the turbine blades 118. As shown in the illustrated example of FIG. 1, the length of each of the impeller blades 116 from the radially inner edge 130 to the radially outer edge 132 is longer than the width or span of the impeller blades 116. Thus, a length of each of the leading edges 134 of the impeller blades 116 (approximately corresponding to the width or span of the blades 116) is shorter than the length of the concave side 124 of the impeller blades 116. Likewise, the length of each of the leading edges 134 of the impeller blades 116 is shorter than the length of the convex side 126 of the impeller blades 116. In other examples, the length of the blades 116, 118 may be equal to or less than the width or span of the blades 116, 118.

Furthermore, as shown in FIG. 1, the length of each of the turbine blades 118 from the radially inner edge 130 to the radially outer edge 132 is longer than the width or span of the turbine blades 118. Thus, a length of each of the leading edges 136 of the turbine blades 118 (approximately corresponding to the width or span of the blades 118) is shorter than the length of the concave side 124 of the turbine blades 118. Similarly, the length of each of the leading edges 136 of the turbine blades 118 is shorter than the length of the convex side 126 of the turbine blades 118.

In the illustrated example, while the stator blades 120 may be curved similarly to the impeller blades 116 and the turbine blades 118 about the circular cross-section 128, the stator blades 120 are oriented differently. In particular, the concave side 124 of the stator blades 120 is radially outward of the convex side 126 of the stator blades 120. As a result, the length of the stator blades 120 between a leading edge 142 and a trailing edge 144 generally extends in a direction between the turbine 104 and the impeller 102 with the leading edge 142 closer to the turbine 104 and the trailing edge 144 closer to the impeller 102. Other orientations and/or configurations of the blades 116, 118, 120 may alternatively be implemented. For example, the lengths and relative positions of the impeller blades 116, the turbine blades 118, and the stator blades 120 about the circular cross-section may be different in different torque converter designs.

As shown in the illustrated example, one or more of the leading edges 134 of the impeller blades 116, the leading edges 136 of the turbine blades 118, and the leading edges 142 of the stator blades 120 may include tubercles 146. In the example of FIGS. 1-4, the leading edges of all of the impeller blades 116, the turbine blades 118, and the stator blades 120 have tubercles. However, in other examples, a subset of the blades 116, 118, 120 may not include tubercles. Due to the orientation of the impeller blades 116, the leading edge 134 of the impeller blades 116 and the associated tubercles 146 face toward a center of the torque converter 100 and the corresponding axis of rotation 110. In contrast, the orientation of the turbine blades 118 is such that the leading edge 136 of the turbine blades 118 and the associated tubercles 146 face away from a center of the torque converter 100 and the corresponding axis of rotation 110. Further, while the impeller and turbine blades 116, 118 are oriented generally radially outward from the center of the torque converter 100, the orientation of the stator blades 120 is such that the leading edge 142 of the stator blades 120 and the associated tubercles 146 face toward the turbine 104 and, more particularly, toward the trailing edge 140 or outlet of the turbine blades 118.

The tubercles 146 implement means for reducing stagnation on the leading edges of the corresponding blades 116, 118, 120. The tubercles (i.e., means for reducing stagnation) of the illustrated example reduce leading edge suction on the blades 116, 118, 120 on which they are located, reduce noise generated by the blades 116, 118, 120 on which they are located, and/or increase an upper limit on an angle of attack of fluid at the blades 116, 118, 120 on which they are located. The upper limit on the angle of attack corresponds to the angle at which the onset of flow separation occurs on the blades 116, 118, 120. While the illustrated examples show each of the blades 116, 118, 120 including tubercles 146, in some examples, the tubercles 146 may not be on each of the different blades 116, 118, 120 and/or every one of any type of blade 116, 118, 120. For example, the stator blades 120 may include the tubercles 146 while the impeller blades 116 and the turbine blades 118 may have smooth leading edges 134, 136. Similarly, either (or both) of the impeller blades 116 and the turbine blades 118 may include the tubercles 146 while the other blades 116, 118, 120 may not. Further, in some examples, only the blades on one of the impeller 102, the turbine 104, or the stator 106 may include tubercles 146 while the other two do not. Moreover, in some examples, only a subset of the blades of the impeller, the turbine, or the stator includes tubercles.

FIG. 2 is an isometric view of the example impeller 102 of FIG. 1. As shown in the illustrated example, the impeller 102 includes a plurality of impeller blades 116 circumferentially disposed around a centrally located axis of rotation of the impeller 102. The impeller blades 116 are oriented generally radially outward of a center of the impeller 102 with the radially inner edges 130 closer to the center than the radially outer edges 132. The center of the impeller 102 is located on the axis of rotation 110. In operation, fluid flows from inside the impeller 102 towards the outside of the impeller 102. As such, the radially inner edge 130 of each impeller blade 116 is the leading edge 134 of each impeller blade 116 and the radially outer edge 132 of each impeller blade 116 is the trailing edge 138 of each impeller blade 116. In the illustrated example, the leading edge 134 of the impeller blades 116 includes tubercles 146. In some examples, the tubercles 146 may correspond to rounded protrusions extending out from a baseline surface of the leading edge 134. The tubercles 146 in the example of FIG. 2 are evenly spaced along the leading edge 134 of the impeller blade 116.

FIG. 3 is an isometric view of the example turbine 104 of FIG. 1. As shown in the illustrated example, the turbine 104 includes a plurality of turbine blades 118 circumferentially disposed around a centrally located axis of rotation of the turbine 104. The turbine blades 118 include radially inner edges 130 that are closer to a center of the turbine 104 than radially outer edges 132. The center of the turbine 104 is aligned with the axis of rotation 110. In operation, as fluid is moved by the impeller 102, the fluid is directed towards the radially outer edges 132 of the turbine blades 118 and then along the blades towards the center of the torque converter. As such, the radially outer edge 132 of each turbine blade 118 is the leading edge 136 of each turbine blade 118 and the radially inner edge 130 of each turbine blade 118 is the trailing edge 140 of each turbine blade 118. In addition to being curved according to the circular cross-section 128 to facilitate meridional flow as described above, the turbine blades 118 may be curved along their length between their leading edge 136 and their trailing edge 140. That is, the inlet angle associated with the leading edge 136 is not in alignment with the outlet angle associated with the trailing edge 140. As a result, the turbine blades 118 define a concave pressure surface 302 and a convex suction surface 304. Additionally, as shown in the illustrated example, the leading edge 136 of the turbine blades 118 may include tubercles 146. In some examples, the tubercles 146 may correspond to rounded protrusions extending out from a baseline surface of the leading edge 136. The tubercles 146 in the example of FIG. 3 are evenly spaced along the leading edge 136 of the turbine blade 118.

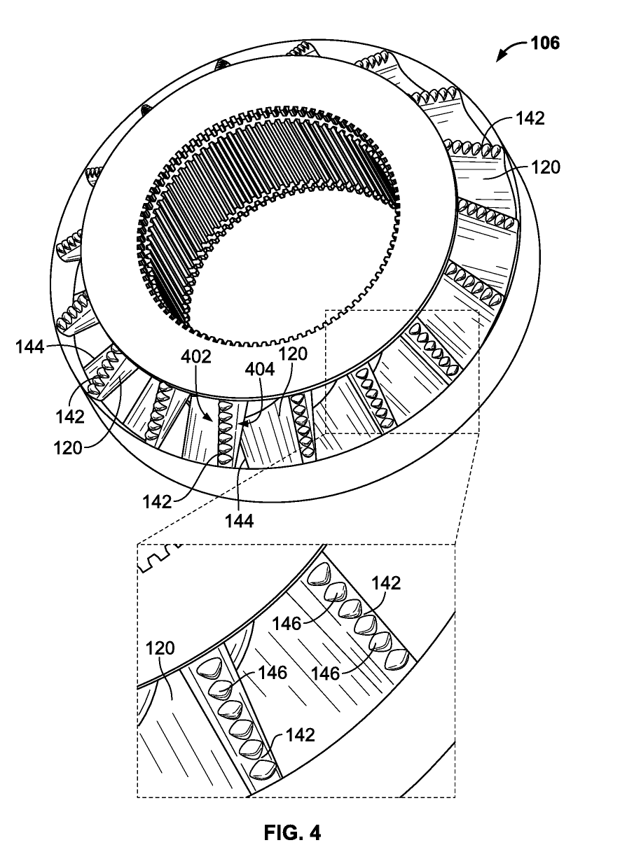

FIG. 4 is an isometric view of the example stator 106 of FIG. 1. As shown in the illustrated example, the stator 106 includes a plurality of stator blades 120 circumferentially disposed around a centrally located axis of rotation of the stator 106. The axis of rotation of the stator 106 is aligned with the axis of rotation 110 of the torque converter 100 as shown in FIG. 1. Each of the example stator blades 120 includes a leading edge 142 that faces toward the turbine 104 and a trailing edge 144 that faces toward the impeller 102 such that fluid from an outlet of the turbine 104 is redirected to an inlet of the impeller 102. As shown in the illustrated example, the leading edge 142 of a first one of the stator blades 120 overlaps the trailing edge 144 of an adjacent stator blade 120 in a direction parallel to an axis of rotation of the stator 106 (e.g., corresponding to the axis of rotation 110 shown in FIG. 1). In the illustrated example, the leading edge 142 of the stator blades 120 includes tubercles 146. As shown, in some examples, the tubercles 146 may correspond to rounded protrusions extending out from a baseline surface of the leading edges 142. The tubercles 146 in the example of FIG. 4 are evenly spaced along the leading edges 142 of the stator blades 120.

In addition to being curved according to the circular cross-section 128 to facilitate meridional flow as described above, the stator blades 120 may be curved along their length between their leading edge 142 and their trailing edge 144. That is, the inlet angle associated with the leading edge 142 is not in alignment with the outlet angle associated with the trailing edge 144. As a result, the stator blades 120 define a concave pressure surface 402 and a convex suction surface 404. When the torque converter 100 is assembled with the leading edges 142 of the stator blades 120 facing towards the turbine 104 (as shown in FIG. 1), the stator blades 120 are curved in the opposite direction as the corresponding turbine blades 118. That is, the concave pressure surface 402 of a stator blade 120 faces in the opposite direction as the concave pressure surface 302 of an adjacent turbine blade 118. This different (e.g., inversion) in the curved direction of the turbine blades 118 and the stator blades 120 facilitates the redirection of the fluid between the turbine 104 and the impeller 102.

FIG. 5 is an isometric view of another example impeller 500 that may alternatively be implemented in the example torque converter 100 of FIG. 1. The example impeller 500 of FIG. 5 is similar to the example impeller 102 of FIG. 2 except that the impeller blades 502 of the impeller 500 of FIG. 5 include different means for reducing stagnation. In particular, the means for reducing stagnation is implemented by the tubercles 504 defined by a generally scalloped contour 501 formed along the leading edge 508 of the impeller blades 502. The scalloped contour 501 may be formed by machining divots or notches 506 into the initially smooth leading edges 508 of the impeller blades 502. In some examples, the notches 506 may traverse the blade 502 in a substantially straight line such that ridges 510 are formed at the interface of the original surface of the impeller blades 502 and the top walls of the notches 506. In other examples, the notches 506 may be curved and/or the ridges 510 may be rounded to provide a smooth transition between the surfaces.

FIG. 6 is an isometric view of another example turbine 600 that may alternatively be implemented in the example torque converter 100 of FIG. 1. The example turbine 600 of FIG. 6 is similar to the example turbine 104 of FIG. 3 except that turbine blades 602 of the turbine 600 of FIG. 6 include different means for reducing stagnation along a leading edge 606 of the turbine blades 602. The means for reducing stagnation is implemented by tubercles 604 in the illustrated example of FIG. 6 are similar to the example tubercles 504 shown and described above in connection with FIG. 5.

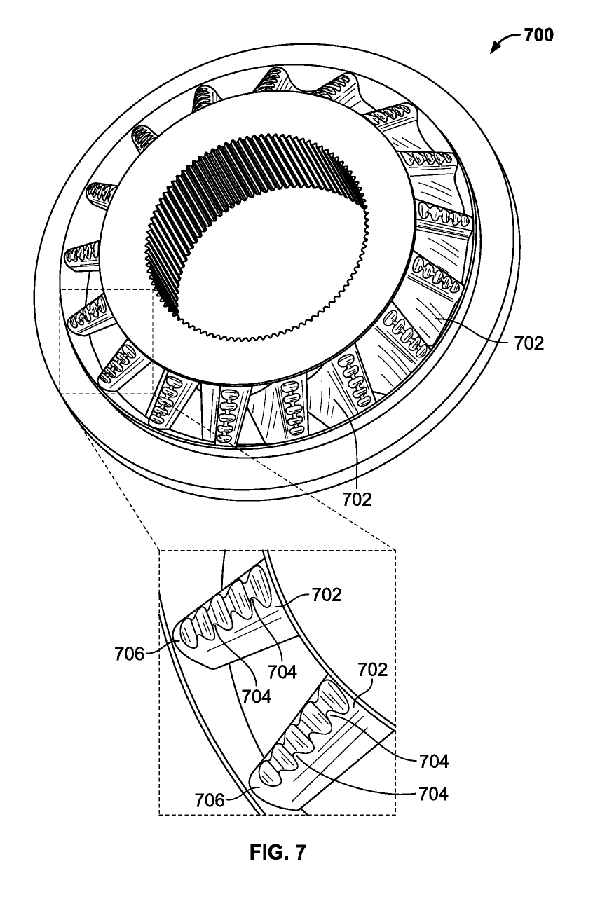

FIG. 7 is an isometric view of another example stator 700 that may alternatively be implemented in the example torque converter 100 of FIG. 1. The example stator 700 of FIG. 7 is similar to the example stator 106 of FIG. 4 except that stator blades 702 of the stator 700 of FIG. 7 include different means for reducing stagnation along a leading edge 706 of the stator blades 702. The means for reducing stagnation is implemented by tubercles 704 in the illustrated example of FIG. 7. The example tubercles 604 of FIG. 6 are similar to the example tubercles 504 shown and described above in connection with FIG. 5.

The examples of FIGS. 2-7 may be mixed in any combination. For examples, one or more of the impeller 102, the turbine 104, and/or the stator 106 may be combined in a torque converter with one or more of the impeller 500, the turbine 600, and/or the stator 700. Further, some blades on any one of the example impellers 102, 500, the example turbines 104, 600, and/or the example stators 106, 700 may include the tubercles 146 described in FIGS. 2-4 protruding from a baseline surface while other blades include the tubercles 504, 604, 704 described in FIGS. 5-7 formed by removing material from a baseline surface. Additionally or alternatively, in some examples, individual blades may include rounded protrusions (similar to the tubercles 146 shown in FIGS. 2-5) as well as divots or other shaped recesses (similar to the notches 506 shown in FIG. 5) therebetween.

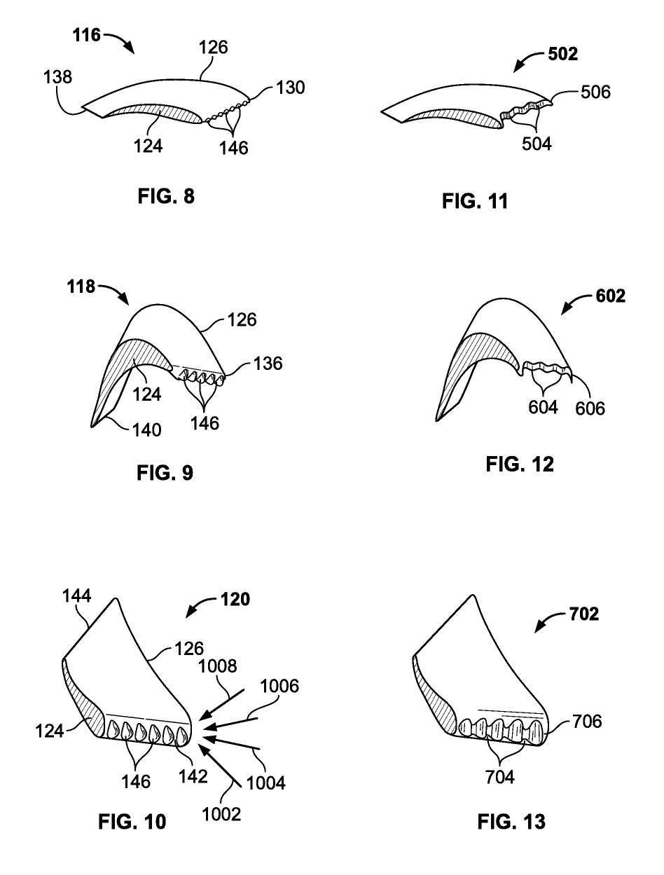

FIG. 8 is a cutaway view of a single example impeller blade 116 of the example impeller 102 of FIG. 2. FIG. 9 is a cutaway view of a single example turbine blade 118 of the example turbine 104 of FIG. 3. FIG. 10 is a cutaway view of a single example stator blade 120 of the example stator 106 of FIG. 4. Each of the example impeller blade 116, the example turbine blade 118, and the example stator blade 120 includes a corresponding leading edge 134, 136, 142 and a corresponding trailing edge 138, 140, 144 spanning between a curved concave side 124 and a curved convex side 126. The curved concave side 124 is on an opposite side of the blade than the curved convex side 126. Further, each of the leading edges 134, 136, 142 includes tubercles 146 spaced along its length. The tubercles 146 may be rounded protrusions formed on the leading edges 134, 136, 142 of the respective blades 116, 118, 120 (as shown in FIGS. 8-10). Such tubercles 146 may be formed as part of the casting process for each of the impeller 102, the turbine 104, and the stator 106.

Depending on the relative rotational speeds of the impeller 102 and/or the turbine 104, the angle of attack of the leading edge 142 of the stator blade 120 relative to the direction of flow can vary significantly. For example, the arrows 1002, 1004, 1006, 1008 in FIG. 10 (each of which are to be viewed in a common plane substantially perpendicular to the leading edge 142) illustrate approximations of the fluid flow direction relative to the stator blade 120 for different speed ratios between the turbine 104 and the impeller 102. The fluid flow is represented as an approximation because torque converters involve complex flow paths that include meridional flow (due to fluid being forced from the impeller blades 116 to the turbine blades 118, to the stator blades 120 and then back to the impeller blades) as well as rotational flow (due to the rotation of the impeller 102, the turbine 104, and/or the stator 106).

The shallowest angle of attack (i.e., the flow direction most in line with the inlet angle of the stator blade 120) is represented by the lowest arrow 1002 and may occur at a speed ratio of 1 (e.g., when the turbine 104 is rotating at the same speed as the impeller 102). At the opposite extreme, the steepest angle of attack is represented by the highest arrow 1008 and may occur at a speed ratio of 0 (e.g., when the turbine 104 is not rotating). Different speed ratios between 0 and 1 may result in different flow directions between these two extremes. For example, the flow direction represented by the second arrow 1004 from the bottom may correspond to a speed ratio of 0.7 while the third arrow 1006 may correspond to a speed ratio of 0.3. Thus, as the speed ratio between the turbine 104 and the impeller 102 approaches 0, the angle of attack of the stator blade may increase. At such high angles of attack, there is an increased possibility of flow separation when a boundary layer of fluid detaches from the surface of the blade rather than remaining attached between the leading edge through to the trailing edge of the blade. Flow separation results in reduced power output and/or reduced efficiency by a torque converter. The tubercles 146 along the leading edge of the stator blades 120 may serve to improve the efficiency of a torque converter because the tubercles 146 may delay flow separation (at high angles of attack) as outlined above. That is, the tubercles may increase an upper limit on the angle of attack at which point flow separation occurs. Additionally or alternatively, the tubercles 146 may enable stator blades designed to experience higher angles of attack than would be possible without the tubercles 146, thereby enabling greater power outputs in certain operational regions.

In many applications where airfoils are used, such high angles of attack as experienced by a stator in a torque converter rarely occur. Furthermore, when a relatively steep angle of attack occurs, the high angle often occurs during only a brief period relative to the entire duty cycle of the application. For example, the wings on an airplane experience relatively high angles of attack (although not as high as experienced by a stator in a torque converter) during take-off. However, after gaining altitude, the airplane levels off and a lower angle of attack is experienced the rest of the flight. As a result, the potential benefit of adding tubercles to the front edge of a wing to reduce flow separation during high angles of attack is marginal and may be outweighed by the cost and complexity in manufacturing such wings. By contrast, a large portion of the duty cycle of a torque converter in some heavy equipment vehicles (e.g., bulldozers, loaders, mining equipment, steel factory vehicles, agricultural equipment, etc.) occurs during operational states where the speed ratio is near 0 corresponding to high angles of attack. As a result, high angles of attack are experienced for extended periods of time in the context of torque converters for heavy equipment vehicles. Further, some heavy equipment vehicles involve quick directional shifts that may even result in a negative speed ratio (e.g., the turbine rotating in the opposite direction to the impeller) resulting in even higher angles of attack. Therefore, there may be potential to realize more than marginal increases in efficiency in a torque converter for a heavy equipment vehicle because of the extended periods of time where the stator is experiencing a high angle of attack. As used herein, a high angle of attack is above 15 degrees.

FIG. 11 is a cutaway view of a single example impeller blade 502 of the example impeller 500 of FIG. 5. FIG. 12 is a cutaway view of a single example turbine blade 602 of the example turbine 600 of FIG. 6. FIG. 13 is a cutaway view of a single example stator blade 702 of the example stator 700 of FIG. 7. The impeller blade 502, the turbine blade 602, and the stator blade 702 of FIGS. 11-13 may be constructed similarly to the impeller, turbine, and stator blades 116, 118, 120 of FIGS. 8-10 except that the leadings edges 508, 606, 706 of the corresponding blades 502, 602, 702 includes tubercles 504, 604, 704 defined by notches, divots, or other shaped recesses cut into the leading edges 508, 606, 706. That is, the tubercles 504, 604, 704 may be formed by removing material (e.g., via machining) from the leading edge 508, 606, 706 at spaced apart intervals to define protruding portions where material was not removed. In some examples, the blades 502, 602, 702 are initially cast with a smooth leading edge 508, 606, 706 to define a baseline surface into which the notches, divots, or other shaped recesses are formed.

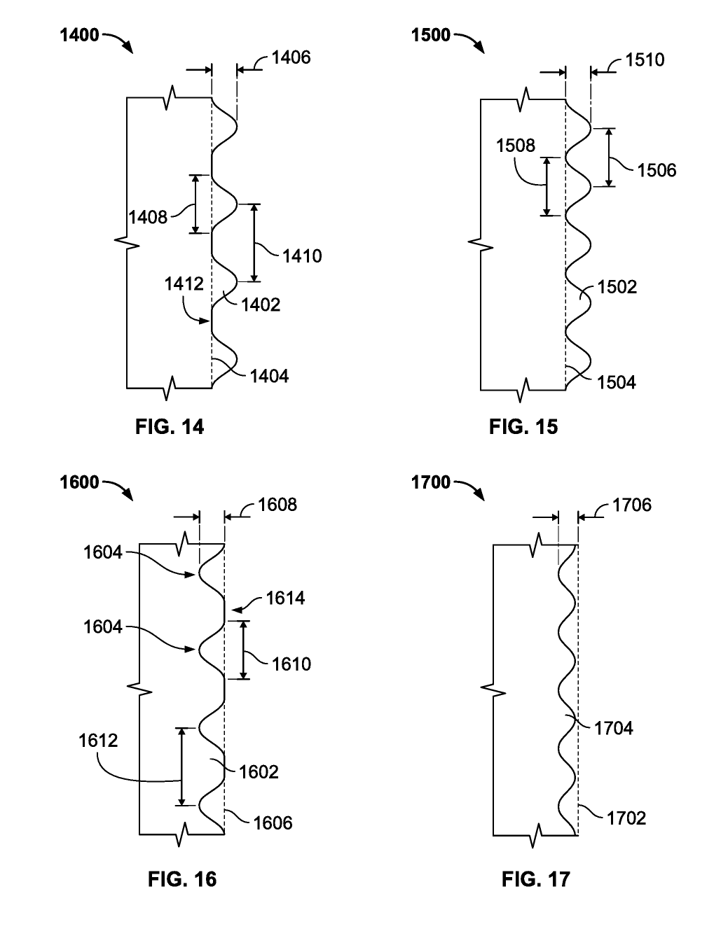

FIGS. 14 and 15 are plan views of example leading edges 1400, 1500 of blades similar to the example impeller blades 116, turbine blades 118, and stator blades 120 of FIGS. 2-4 and 8-10. As shown in the illustrated examples, the leading edge 1400 include tubercles 1402 corresponding to nodules or rounded protrusions extending out from a baseline surface 1404 (represented with a dotted line). In some examples, the tubercles 1402 may be defined by molds used during the casting process to fabricate the corresponding impeller, turbine, or stator. As such, the baseline surface 1404 in the illustrated examples may not correspond to an initial state of the leading edge but is representative of the surface of the blade surrounding the tubercles 1402 and/or is representative of how a leading edge without the tubercles 1402 may appear.

Each tubercle 1402 includes a height 1406 and a width 1408. In some examples, the tubercles 1402 are separated by a spacing 1410 that is greater than their width 1408. As a result, there may be a region 1412 (e.g., a land) between adjacent tubercles 1402 corresponding to the baseline surface 1404. By contrast, the leading edge 1500 of the example blade of FIG. 15 includes tubercles 1502 extending out from a baseline surface 1504 that have a spacing 1506 that is equal to a width 1508 of the tubercles 1502 such that the tubercles 1502 define a sine waveform-like profile for the leading edge 1500.

In some examples, one or more of the height 1406, 1510, the width 1408, 1508, and/or the spacing 1410, 1506 of the tubercles 1402 of FIG. 14 or the tubercles 1502 of FIG. 15 may be different for the blades on the impeller 102, the turbine 104, and/or the stator 106 due to differences in geometry of the blades such as, for example, blade thickness and/or minimum radius at the leading edge. For example, tubercles on the leading edge 142 of the stator blades 120 may have a width (and corresponding spacing) that is greater than tubercles on the leading edge 134 of the impeller blades 116 because the leading edge 142 of the stator blade 120 may be much thicker with a larger minimum radius than the leading edge 134 of the impeller blade 116. Due to the smaller size of the tubercles on the impeller blade 116, the number of tubercles on the leading edge 134 of the impeller blade 116 may be greater than the number of tubercles on the leading edge 142 of the stator blade 120. Similarly, the leading edge 134 of the impeller blade 116 may have more tubercles than the leading edge 136 of the turbine blade 118. In some such examples, the height of the tubercles may be equal for both blades despite the difference in width and spacing, while in other examples, the height of the tubercles on each of the blades may be adjusted correspondingly to the width and spacing. In other examples, the spacing of tubercles may be consistent for the blades of each of the impeller, the turbine, and the stator such that the number of tubercles depends on the length of the leading edge of each blade. Thus, where the leading edge 142 of the stator blade 120 is longer than the leading edge 134 of the impeller 116 (as shown in FIG. 1), the number of tubercles on the leading edge 134 of the impeller blade 116 may be less than the number of tubercles on the leading edge 142 of the stator blade 120, In some examples, the spacing of the tubercles may range from between 2 mm and 10 mm with a height ranging from between 2 mm and 10 mm depending on the size of the torque converter. In some examples, the spacing of the tubercles is approximately equal to the height of the tubercles.

FIGS. 16 and 17 illustrate plan views of example leading edges 1600, 1700 similar to the example impeller blades 502, turbine blades 602, and stator blades 702 of FIGS. 5-7 and 11-13. As shown in the illustrated examples, the leading edge 1600 includes tubercles 1602 corresponding to protruding regions defined by divots or notches 1604 that are cut or formed into a baseline surface 1606 (represented with a dotted line). Thus, the baseline surface 1606 of FIG. 16 may be representative of an initial surface of the leading edge 1600 when the corresponding impeller, turbine, or stator is being fabricated (e.g., at an intermediate state of fabrication).

Each tubercle 1602 includes a height 1608 and a width 1610. In some examples, the tubercles 1402 are separated by a spacing 1612 that is greater than their width 1610. As a result, there may be a region 1614 corresponding to the peak of a tubercle 1402 that corresponds to the baseline surface 1606. By contrast, most of or the entire length of the leading edge 1700 of FIG. 17 is machined below the initial baseline surface 1702, thereby enabling a rounded shape for the resulting tubercles 1704. Due to the additional material removed from the leading edge 1700 in FIG. 17 relative to the leading edge 1600 of FIG. 16, the height 1706 of the tubercles 1704 of FIG. 17 are shorter than the height 1608 of the tubercles 1602 of FIG. 16. In other examples, the height 1706 of the tubercles 1704 in FIG. 17 may be the same as or great than the height 1608 of the tubercles 1602 in FIG. 16.

While example tubercles 1402, 1502, 1602, and 1704 have been shown and described in FIGS. 14-17, other tubercles may additionally or alternatively be implemented. For example, the tubercles on a particular blade may be of different sizes depending upon their location on the leading edge of the blades. For example, a tubercle closest to the concave side 124 (FIG. 1) of a leading edge of a blade may be a different size than the tubercle closest to the convex side 126 (FIG. 1) of the blade to account for different flow characteristics at each point due to centrifugal forces from the meridional flow of fluid within a torque converter. Additionally or alternatively, the spacing of tubercles closest to the concave side 124 of a leading edge of a blade may be different than the spacing of tubercles closest to the convex side of the blade. Furthermore, the height, width, spacing, shape, and/or orientation of the tubercles and/or the valley regions (e.g., lands) therebetween may be suitably altered in manners other than those shown and described above.

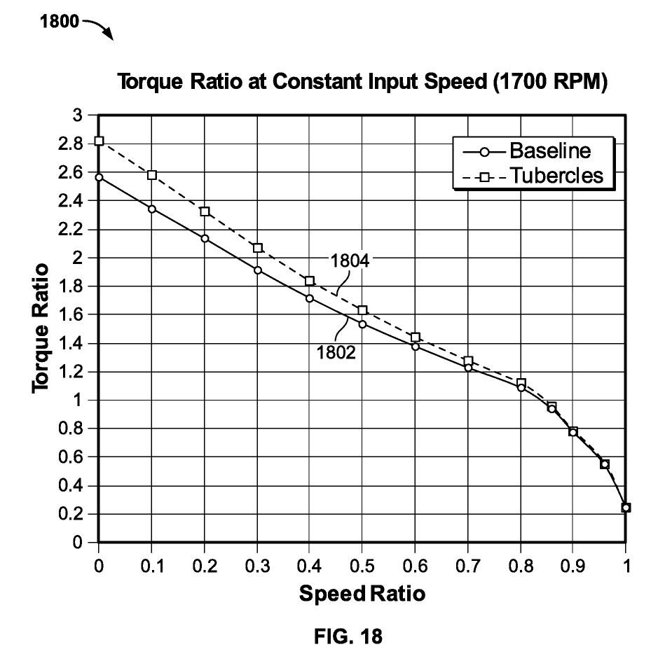

FIG. 18 is a chart 1800 illustrating estimated increases in torque ratio achieved by examples disclosed herein. The solid line 1802 is representative of typical torque ratios achieved by a torque converter with impeller, turbine, and stator blades including smooth leading edges. The dashed line 1804 is representative of estimated torque ratios achieved by a torque converter under the same conditions with impeller, turbine, and stator blades including tubercles spaced along their leading edges. As shown in the chart 1800, the torque ratio is estimated to improve by about 10% to 4% for speed ratios ranging from 0 to 0.7. The speed ratio corresponds to the speed of rotation of the turbine divided by the speed of rotation of the impeller. This increased performance translates into increased efficiency, which may be calculated by multiplying the torque ratio by the speed ratio at a given point. The greatest improvements to the torque ratio (and resultant efficiency) are estimated to occur at lower speed ratios (e.g., when the turbine is rotating slower than the turbine) because of the higher angle of attack experienced by stator blades at these operating conditions. For example, in heavy equipment vehicles, much of the duty cycle of torque converters occurs within a range of relatively low speed ratios (e.g., between 0 and 0.7) at which the angle of attack may range from between 15 degrees (at a speed ratio of 0.7) and 90 degrees (at a speed ratio of 0). Further, in some situations, negative speed ratios may be experienced (e.g., during quick directional shifts). Accordingly, tubercles disposed along the leading edge of stator blades within a torque converter may provide greater improvements to efficiency than in most other applications where tubercles may be implemented.

### INDUSTRIAL APPLICABILITY

A torque converter disclosed herein may be used in any type of vehicle and/or other machinery equipment to improve the efficiency by which torque is transferred from a rotational power input (e.g., an engine, a gas turbine, an electric motor, etc.) to an output (e.g., a transmission, a pump, etc.). An example method of operation involves forcing a fluid within a torque converter (e.g., the torque converter 100 of FIG. 1) to move based on rotation of an impeller (e.g., the impeller 102 of FIG. 1 or the impeller 500 of FIG. 5) within the torque converter 100 driven by the rotational power input. The example method further involves rotating a turbine (e.g., the turbine 104 of FIG. 1 or the turbine 600 of FIG. 6) of the torque converter 100 in response to the movement of the fluid to transfer the rotational power input to the output. Further, the example method involves redirecting the fluid moving from the turbine 104 back toward the impeller 102 via a stator (e.g., the stator 106 of FIG. 1 or the stator 700 of FIG. 7) of the torque converter 100. In some examples, at least one of an impeller blade (e.g., the impeller blades 116, 502), the turbine blade (e.g., the turbine blades 118, 602), or the stator blade (e.g., the stator blades 120, 702) includes tubercles (e.g., the tubercles 146, 504, 604, 704, 1402, 1502, 1602, 1704) on a leading edge (e.g., the leading edges 134, 136, 142, 508, 606, 706, 1400, 1500, 1600, 1700). The tubercles may improve the flow characteristics and, thus, the efficiency and/or power transfer of the torque converter 100.

In particular, including the tubercles 146, 504, 604, 704, 1402, 1502, 1602, 1704 on the impeller blades 116, 502, the turbine blades 118, 602, and/or the stator blades 120, 702 of a torque converter as disclosed herein may reduce stagnation on the leading edge of the blades. Stagnation corresponds to when the local velocity of a fluid is zero or nearly zero. Low flow velocity at the leading edge of a blade results in higher pressure on the leading edge, thereby resulting in drag on the blade. Drag on torque converter blades requires energy to overcome the barrier, thereby reducing the power or torque transferred by the torque converter. The tubercles 146, 504, 604, 704, 1402, 1502, 1602, 1704 on the leading edge of a blade produce uneven, undulating, and/or non-linear leading edges that reduce stagnation by directing oncoming fluid into channels between the tubercles 146, 504, 604, 704, 1402, 1502, 1602, 1704 with a higher velocity than would occur on a smooth leading edge. The increased velocity of the fluid results in a decrease in the pressure in the region. The lower pressure regions result in less stagnation in those regions. Put another way, whereas stagnation may occur along the entire length of the leading edge of a blade that is smooth, stagnation on the leading edge of a blade that includes tubercles may be localized to discretely spaced regions corresponding to the spacing of the tubercles with high speed flow channels passing therebetween. Reduced stagnation results in less drag and reduced leading edge suction such that a more efficient transfer of torque is possible than with a smooth leading edge not having tubercles.

Furthermore, the high speed flow channels created by the tubercles 146, 504, 604, 704, 1402, 1502, 1602, 1704 on the leading edge of the blades 116, 118, 120, 502, 602, 702 may improve the efficiency of the torque converter 100 in other ways in addition to reducing stagnation. For example, in an ideal setting, fluid flowing across a blade will follow a path that moves from the leading edge of the blade toward its trailing edge (i.e., the rear or outlet edge of a blade) in a direction generally perpendicular to the leading and trailing edges. However, due to the curved geometry of the blades 116, 118, 120, 502, 602, 702 and centrifugal forces in the torque converter 100 disclosed herein, fluid flow may not follow the ideal fluid path but may cross at an angle relative to the direction perpendicular to the leading and trailing edges. The component of the velocity vector of fluid flow in a direction perpendicular to the leading and trailing edges of a blade is referred to as the chordwise flow component. The component of the velocity vector of fluid flow in a direction parallel to the leading and trailing edges is referred to as the spanwise flow component. Spanwise flow can negatively impact the performance of a blade. However, the high speed flow channels generated by the tubercles 146, 504, 604, 704, 1402, 1502, 1602, 1704 included on the leading edge of the example impeller blades 116, 502, the example turbine blades 118, 602, and/or the example stator blades 120, 702 as disclosed herein may break up and/or redirect spanwise flow to reduce its negative impact.

Additionally, the high speed flow channels generated by the tubercles 146 may facilitate a delay in flow separation (such that the location of flow separation occurs further back from the leading edge of the blades 116, 118, 120 and/or enable higher angles of attack of fluid on the leading edges of blades 116, 118, 120 before the onset of flow separation). While flow separation may not be a concern for shallow angles of attack, flow separation becomes more likely, and, thus, raises a greater concern of reducing efficiency, as the angle of attack increases. Depending on the speed ratio of the torque converter 100 (e.g., the ratio of turbine speed to impeller speed), the leading edge of the stator blades 120, 702 may be subject to a broad range of angles of attack. For example, when the turbine 118, 602 is rotating approximately at the same speed as the impeller 116, 502 (e.g., speed ratios at or around 1), the angle of attack of the stator 120, 702 is relatively low. However, when the turbine 118, 602 is rotating much slower than the impeller 116, 502 (e.g., speed ratios at or near zero), the angle of attack of the stator 120, 702 can approach 90 degrees. Flow separation is likely to occur on the stator 120, 702 at some angle between these two extremes resulting in less torque transferred and, thus, less efficient operation. By including tubercles 146, 504, 604, 704, 1402, 1502, 1602, 1704 on the leading edge of the blades (impeller, turbine, and/or stator blades), as disclosed herein, the angle at which flow separation occurs may increase when compared with a smooth leading edge. Thus, better flow characteristics may result, particularly at operating regions where the angle of attack is relatively high (e.g., for speed ratios at or near zero). This advantage is particularly relevant to torque converters in heavy equipment vehicles that may operate at relatively low speed ratios during a large portion of their duty cycle.

Further, leading edge stagnation gives rise to leading edge suction. As such, by reducing stagnation of the leading edge of the blades 116, 118, 120, 502, 602, 702 of the torque converter 100 using the tubercles 146, 504, 604, 704, 1402, 1502, 1602, 1704 as disclosed herein, the leading edge suction may also be reduced. Further still, the example tubercles 146, 504, 604, 704, 1402, 1502, 1602, 1704 disclosed herein may reduce the noise created by the torque converter 100.

Although certain example apparatus, methods, and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A torque converter, comprising:
an impeller including an impeller blade;
a turbine including a turbine blade; and
a stator disposed between the impeller and the turbine, the stator including a stator blade, at least one of a leading edge of the impeller blade, a leading edge of the turbine blade, or a leading edge of the stator blade including tubercles.

2. The torque converter of claim 1, wherein the tubercles are spaced along the leading edge of the impeller blade, the impeller blade including an outer edge relative to an axis of rotation of the impeller, the leading edge of the impeller blade closer to the axis of rotation of the impeller than the outer edge.

3. The torque converter of claim 1, wherein the tubercles are spaced along the leading edge of the turbine blade, the leading edge of the turbine blade being an outer edge of the turbine blade relative to an axis of rotation of the turbine.

4. The torque converter of claim 1, wherein the tubercles are spaced along the leading edge of the stator blade, the leading edge of the stator blade facing toward a trailing edge of the turbine blade.

5. The torque converter of claim 1, wherein the tubercles are spaced along the leading edge of the impeller blade, the leading edge of the turbine blade, and the leading edge of the stator blade, a number of tubercles on the leading edge of the impeller blade being greater than a number of the tubercles on the leading edge of the turbine blade and greater than a number of the tubercles on the leading edge of the stator blade.

6. The torque converter of claim 1, wherein the tubercles are rounded protrusions formed during a casting process of at least one of the impeller, the turbine, or the stator.

7. The torque converter of claim 1, wherein the tubercles are formed by removing material from the at least one of the leading edge of the impeller blade, the leading edge of the turbine blade, or the leading edge of the stator blade at spaced apart intervals.

8. The torque converter of claim 1, wherein at least one of:
(a) the leading edge of the impeller blade has a first length, a side of the impeller blade is a second length, the first length shorter than the second length, or
(b) the leading edge of the turbine blade has a third length, a side of the turbine blade is a fourth length, the third length shorter than the fourth length.

9. The torque converter of claim 1, wherein the leading edge of the impeller blade faces toward a center of the torque converter, the leading edge of the turbine blade faces away from the center of the torque converter, the tubercles on the leading edge of the impeller blade face toward the center of the torque converter, and the tubercles on the leading edge of the turbine blade face away from the center of the torque converter.

10. The torque converter of claim 1, further including:
an engine, and transmission, the torque converter coupling the engine and the transmission.

11. The torque converter of claim 1, wherein the tubercles are defined by a scalloped contour formed along the at least one of the leading edge of the impeller blade, the leading edge of the turbine blade, or the leading edge of the stator blade.

12. An apparatus, comprising:
an impeller including an impeller blade;
a turbine including a turbine blade;
a stator including a stator blade, the stator disposed between the impeller and the turbine; and
means for reducing stagnation on a leading edge of at least one of the impeller blade, the turbine blade, or the stator blade.

13. The apparatus of claim 12, wherein the means for reducing stagnation reduces leading edge suction on the at least one of the impeller blade, the turbine blade, or the stator blade.

14. The apparatus of claim 12, wherein the means for reducing stagnation reduces noise generated by the at least one of the impeller blade, the turbine blade, or the stator blade.

15. The apparatus of claim 12, wherein the means for reducing stagnation increases an upper limit on an angle of attack of the at least one of the impeller blade, the turbine blade, or the stator blade, the upper limit corresponding to when flow separation occurs on the at least one of the impeller blade, the turbine blade, or the stator blade.

16. The apparatus of claim 12, wherein the means for reducing stagnation is implemented by tubercles spaced along a leading edge of the at least one of the impeller blade, the turbine blade, or the stator blade.

17. A method comprising:
forcing a fluid within a torque converter to move based on rotation of an impeller within the torque converter driven by a rotational power input, the impeller including an impeller blade;
rotating a turbine in response to movement of the fluid to transfer the rotational power input to an output, the turbine including a turbine blade; and
redirecting the fluid moving from the turbine toward the impeller via a stator, the stator including a stator blade, at least one of the impeller blade, the turbine blade, or the stator blade includes tubercles on a leading edge.

18. The method of claim 17, wherein at least one of:
(a) the tubercles are on the leading edge of the impeller blade, the impeller blade including a radially outer edge, the leading edge of the impeller blade closer to an axis of rotation of the impeller than the radially outer edge, or
(b) the tubercles are on the leading edge of the turbine blade, the leading edge of the turbine blade being a radially outer edge of the turbine blade.

19. The method of claim 17, wherein the tubercles are on the leading edge of the stator blade, the leading edge of the stator blade facing toward a trailing edge of the turbine blade.

20. The method of claim 17, wherein the tubercles are fabricated on the at least one of the impeller blade, the turbine blade, or the stator blade by removing material from the leading edge of the at least one of the impeller blade, the turbine blade, or the stator blade to define the tubercles.
